(19) United States
(12) Patent Application Publication
(10) Pub. No.: US 2013/0320674 A1
(43) Pub. Date: Dec. 5, 2013

(54) Net Present Value Optimized Wind Turbine Operation

(71) Applicant: Benjamin Ingram, Santa Clara, CA (US)

(72) Inventor: Benjamin Ingram, Santa Clara, CA (US)

(73) Assignee: Clipper Windpower, LLC, Carpinteria, CA (US)

(21) Appl. No.: 13/483,199

(22) Filed: May 30, 2012

(51) Int. Cl. H02P 9/04

(52) U.S. Cl. 290/43

(57) ABSTRACT

A wind turbine control system operates a wind turbine and controls the amount of power output at maximum power output conditions to achieve the goal of emphasizing power generation in the present at the expense of power generation in the future. Because of the time value of money, a given quantity of electric power generated in the present is worth much more than the same quantity generated, for instance, 10 years in the future. Recognizing the time value of money impact on the net present value of installing and operating a wind turbine, the control system would optimize the net present value by producing more power in the turbine's early years than in its later years. The control system may also optimize return on investment by adjusting the power output based on the energy price during a current period versus the energy price forecast in a future period.

### FIELD OF THE DISCLOSURE

The present disclosure generally relates to wind turbines and, more particularly, relates to control strategies for increasing the return on investment of the wind turbine by optimizing its maximum rated power.

### BACKGROUND OF THE DISCLOSURE

A utility-scale wind turbine typically includes a set of two or three large rotor blades mounted to a hub. The rotor blades and the hub together are referred to as the rotor. The rotor blades, through aerodynamic interaction with the incoming wind, generate lift, which is then translated into a driving torque by the rotor. The rotor is attached to and drives a main shaft, which in turn is operatively connected via a drive train to a generator or a set of generators that produce electrical power. The power P generated by the wind turbine is equal to the product of an angular velocity Ω of the main shaft multiplied by a torque τ applied to the main shaft by the generators. The main shaft, the drive train and the generator(s) are all situated within a nacelle, which rests on a yaw system that continuously pivots along a vertical axis to keep the rotor blades facing in the direction of the incoming wind.

A typical or ideal power curve 1 for a wind turbine is shown in FIG. 1. The power curve 1 is a graph of the wind speed ω versus the power P output by the wind turbine. The rotor may pinwheel or free wheel below a cut-in wind speed 2 without driving the generators to produce electricity. At the cut-in wind speed 2, the rotor and, correspondingly, the main shaft begin to drive the generators as the torque τ increases to produce electrical power. As the wind speed ω increases within a region I, the angular velocity Ω of the main shaft and the power P output by the wind turbine increase until the angular velocity Ω reaches a rated angular velocity Ω^{r} and the power curve 1 enters a region II. As the wind speed ω continues to increase, the angular velocity Ω remains constant at the rated angular velocity Ω^{r} as the torque τ applied to the main shaft by the generators increases to increase the power output by the wind turbine until the rated wind speed 3 causes the rated power P^{r} to be output by the wind turbine. As can be seen, when the wind reaches its rated speed 3, any further power output increase is prevented as the wind speed ω increases into a region III. In region III, the output power P is limited or controlled, typically by pitching the rotor blades out of the wind toward a feathered position. If the wind speed ω continues to increases beyond a cut-out wind speed 4, the blades may be rotated to the full feathered position into the direction of the wind to substantially reduce the torque generated by the rotor and prevent damage to the components of the wind turbine caused by high wind conditions.

The wind turbine is designed to produce power at its rated power output under a certain set of standard environmental conditions, including assumed wind speed, turbulence, temperature, density, and the like. At rated power and under these standard environmental conditions, the stresses and strains on structures and components, the temperatures of the gearbox oil and the generators, the current and voltages in the electrical system hardware, and the like, will all remain within their respective extreme design parameters. In addition to designing the machine to withstand these extreme parameters, the machine must be designed for adequate fatigue life that matches or exceeds the intended design life. Additional assumptions are made about how the wind conditions change over time, i.e. what portion of the time will the wind be in region I in the power curve 1 of FIG. 1, and what portion of the time in region III. Given this set of ideal assumptions, the fatigue life of each component and structure is calculated to ensure it meets or exceeds the intended design life. Thus a wind turbine is designed to live within an envelope of extreme instantaneous loads, and designed to have a sufficient fatigue life to meet the intended design life.

A wind turbine has a finite life span like any other industrial machine. The structures and components eventually wear out and the wind turbine will stop functioning. Current wind turbines are designed to meet a lifespan specification that is typically 20 years. It is expected that the fatigue and other wear and tear will build up during the 20 year lifespan, and at the end the wind turbine will be practically used up and taken out of service or completely overhauled. During the lifespan, the wind turbine will produce electric power that is sold to compensate the owner for the initial capital investment and maintenance costs for the wind turbine. However, the value of the power, due to fluctuating prices and the time value of money, changes over time.

In currently known designs, the wind turbine will operate with a constant rated power P^{r} for the duration of its design life and the components will reach their fatigue limits at the end of the design life so that the owner will be left with minimal unused capacity. FIG. 2 illustrates a graph 5 of rated power P^{r} versus time for the design life of a wind turbine. The line 6 represents a 2.5 MW rated wind turbine operating at the designed rated power P^{r}_{D} for the entire design life. Hence, the line 6 is essentially horizontal, though some variations during periods within the design life of the wind turbine are possible as set forth, for example, in the references discussed below. FIG. 3 provides a graph 7 approximating the damage accumulation in the wind turbine over its design life when operated at the designed rated power P^{r}_{D}. A line 8 shows the annual accumulation of fatigue damage D by the wind turbine, and is also horizontal to match the power curve 6 illustrating that approximately the same amount of fatigue damage D is incurred each year. With a constant amount of fatigue damage D incurred every year, a cumulative damage curve 9 increases linearly from year-to-year with a constant slope as the accumulated fatigue damage D approaches the design limit near the end of the design life. Where the actual winds do not meet the forecast, less fatigue damage D will be incurred and the design limit will not be reached at the end of the design life and a full return on the investment in the wind turbine may not be realized.

Benefits of operating a wind turbine at a power that is higher than the rated power, or “uprating,” have been recognized in the art in an effort to ensure that the turbine components and structures are fully used up according to the design intent at the end of the 20 year life span. For example, U.S. Pat. Appl. Publ. No. 2006/0273595, published on Dec. 7, 2006 to Avagliano et al. (hereinafter “'595 publication”), teaches a technique for operating a wind farm at increased rate power output. The technique includes sensing a plurality of operating parameters of the wind turbine generator, assessing the plurality of operating parameters with respect to respective design ratings for the operating parameters, and intermittently increasing a rated power output of the wind turbine generator based upon the assessment. The '595 publication describes how a wind turbine can operate at its rated power output, i.e. at rated speed and torque, but still be well within the envelope of extreme loads and accumulating fatigue damage at a slower than expected rate, and thus the wind turbine might be able to increase speed and/or torque beyond rated speed and torque, and therefore increase power output, without exceeding the extreme loads and without exceeding the anticipated fatigue damage accumulation. The '595 publication also mentions the possibility that a measurement of accumulated fatigue damage over time could be used as a factor in deciding whether to uprate, but the '595 publication does not suggest uprating to exceed the linear expected damage accumulation rate.

U.S. Pat. Appl. Publ. No. 2009/0295160, published on Dec. 3, 2009 to Wittekind et al. (hereinafter “'160 publication”), teaches a method for operating a wind turbine that includes providing a wind turbine having a variable speed control system, the control system having an initial rotational speed set point. At least two operational parameters are obtained from one or more sensors. An adjusted rotational speed set point greater than the initial rotational speed set point is determined in response to the operational parameter. The control system is configured with the adjusted rotational speed set point. The '160 publication describes in more specific terms the operating parameters that may be considered in the decision about whether to uprate, such as current air density, current wind velocity, turbulence intensity and air density. The implication in the '160 publication is that the amount of increase of the rated speed are determined beforehand so that the current air density and current wind velocity can be inputted into a look-up table or a mathematical formula, and a value representing the acceptable increase in power output is outputted. However, the '160 publication does not provide any details as to how the look-up table or formula are computed. Moreover, the '160 publication does not incorporate accumulated fatigue damage into the determination of whether to uprate the wind turbine.

The types of systems disclosed in the references base their rated power changes on operational parameters and wind conditions, but do not factor in optimal timing for adjusting the rated power to optimize the revenues generated by the wind turbine over its design life. In view of the limitations existing in previously known wind turbine control strategies, a need exists for power control strategy capable of adjusting the maximum or rated power over time to optimize the revenue stream and the net present value of the wind turbine.

### SUMMARY OF THE DISCLOSURE

In one aspect of the present disclosure, the invention is directed to a method of operating a fluid flow turbine. The method of operation may include determining a design rated power for operation of the fluid flow turbine during a design lifetime of the fluid flow turbine, determining an initial actual rated power for the fluid flow turbine, wherein the initial actual rated power is great than the design rated power, initially operating the fluid flow turbine at an actual rated power equal to the initial actual rated power, and decreasing the actual rated power from the initial actual rated power over time.

In another aspect of the present disclosure, the invention is directed to a method of operating a fluid flow turbine. The method of operation may include operating the fluid flow turbine to avoid exceeding a rated power output, establishing an initial rated power output of the fluid flow turbine, and decreasing the rated power output from the initial rated power output over a design lifetime of the fluid flow turbine such that an actual power output of the fluid flow turbine gradually decreases.

In a further aspect of the present disclosure, the invention is directed to a method of operating a fluid flow turbine. The method of operation may include determining a rated power for operating the fluid flow turbine, comparing a current energy price for a current time period for energy generated by the fluid flow turbine to a forecast energy price for a future time period, setting a current period actual rated power equal to a value that is greater than the rated power in response to determining that the current energy price is greater than the forecast energy price, and operating the fluid flow turbine at the current actual rated power during the current time period.

Additional aspects of the invention are defined by the claims of this patent.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is an exemplary power versus wind speed curve for a wind turbine;

FIG. 2 is an exemplary rated power P^{r} versus time graph for a wind turbine operating at a constant rated power P^{r} over its designed service life;

FIG. 3 is an exemplary fatigue damage versus time graph for a wind turbine showing the annual damage incurred and the cumulative damage incurred when operated according to the actual rated power P^{r} curve of FIG. 2;

FIG. 4 is an elevational view of a wind turbine that may implement the temporary uprating system in accordance with at least some embodiments of the present disclosure;

FIG. 5 is a rear schematic illustration of the wind turbine of FIG. 2;

FIG. 6 is a schematic illustration of a wind turbine farm integrating a plurality of the wind turbines of FIG. 2;

FIG. 7 is a rated power P^{r} versus time curve for the wind turbine of FIG. 4 operating with an actual rated power initially greater than the rated power P^{r} and decreasing over time;

FIG. 8 is a fatigue damage versus time graph for the wind turbine of FIG. 4 showing the annual fatigue damage incurred and the cumulative fatigue damage incurred when operated according to the actual rated power P^{r} curve of FIG. 7;

FIG. 9 is a rated power P^{r} versus time graph for the wind turbine of FIG. 4 operating at an initial actual rated power greater than the rated power P^{r} and decreasing over time at a decay rate based on an interest rate and a slope of a damage rate; and

FIG. 10 is a rated torque τ^{r} versus time graph for the wind turbine of FIG. 4 and corresponding to the rated power P^{r} versus time graph of FIG. 10.

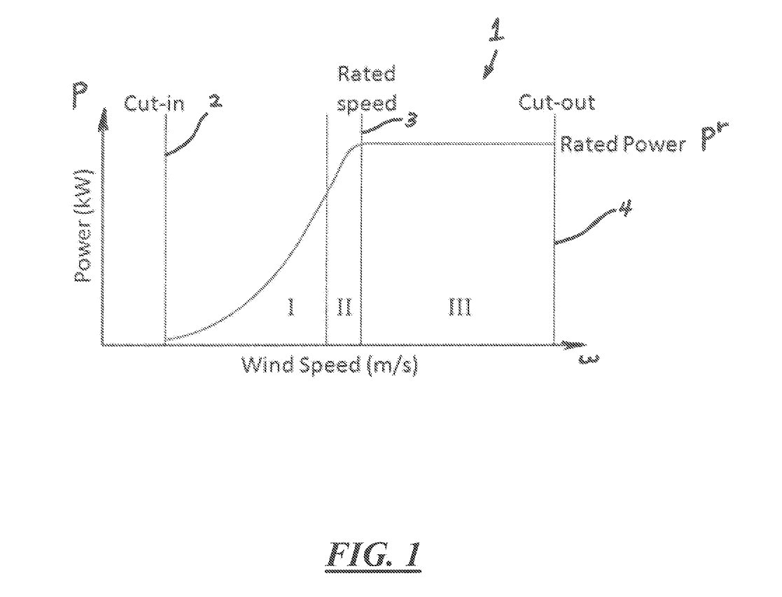

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term “______” is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

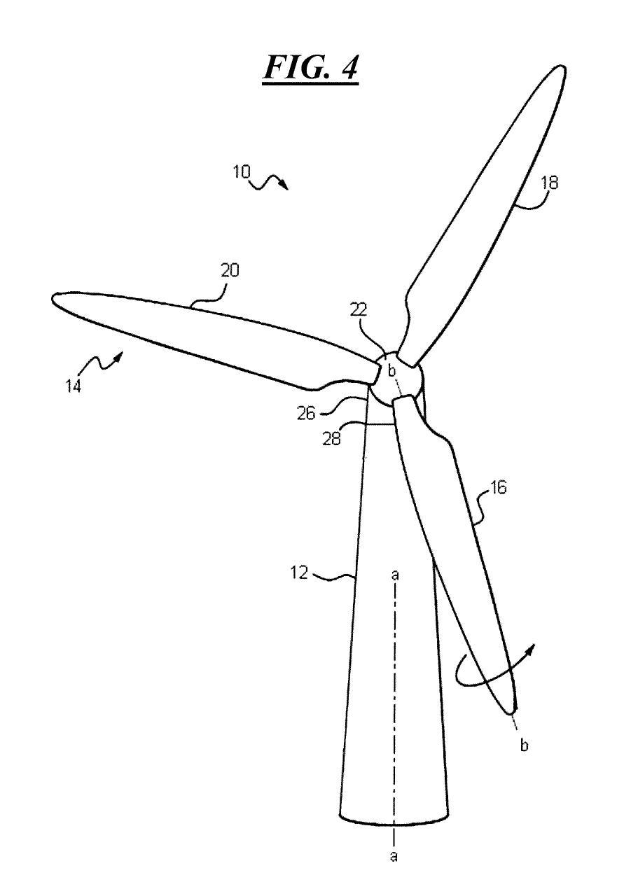

Referring initially to FIG. 4, an exemplary wind turbine 10 is schematically shown in accordance with at least one embodiment of the present disclosure. While all components of the wind turbine are not shown or described herein, the wind turbine 10 may include a vertically standing tower 12 having a vertical axis “a-a”, and supporting a rotor 14. The rotor 14 is defined by a collective plurality of equally spaced rotating blades 16, 18, 20, each connected to and radially extending from a hub 22 as shown. The blades 16, 18, 20 may be rotated by wind energy such that the rotor 14 may transfer such energy via a main shaft (not shown) to one or more generators (not shown). Those skilled in the art will appreciate that such wind-power driven generators may produce commercial electric power for transmission to an electric grid (not shown). Those skilled in the art will appreciate that a plurality of such wind turbines may be effectively employed on a so-called wind turbine farm to generate a significant amount of electric power. Although the disclosed embodiments focus on wind only, this disclosure is pertinent to fluids generally, including other gases and even liquids such as water, that may be used to drive similar turbine structures or other types of power generation structures.

In the embodiments described herein, each of the blades 16, 18, 20 is individually adjustable, i.e. it can be pitched about its radial axis “b-b” (shown only with respect to blade 16 for simplicity) independently of the pitch angle of any other blade. Generally, the blades 16, 18, 20 can be individually pitched toward a feathered position in which the blade produces little or no torque about the hub 22, or toward a power position in which the blade produces a maximum amount of torque about the hub 22.

The hub 22 is attached through a main shaft (not shown) to a nacelle 26 as shown. The nacelle 26 is adapted to revolve about the vertical axis a-a at the top of the tower 12 at the interface 28 of the tower 12 and nacelle 26. Such turntable like nacelle movement is within a generally horizontal plane (not shown) that passes through the interface 28, and is managed by a yaw control system (not shown). The rotatable nacelle 26 may be adapted to freely turn, so as to be able to position the rotor directly perpendicularly to any prevailing winds, and to thereby optimize power generation under conditions of shifting winds.

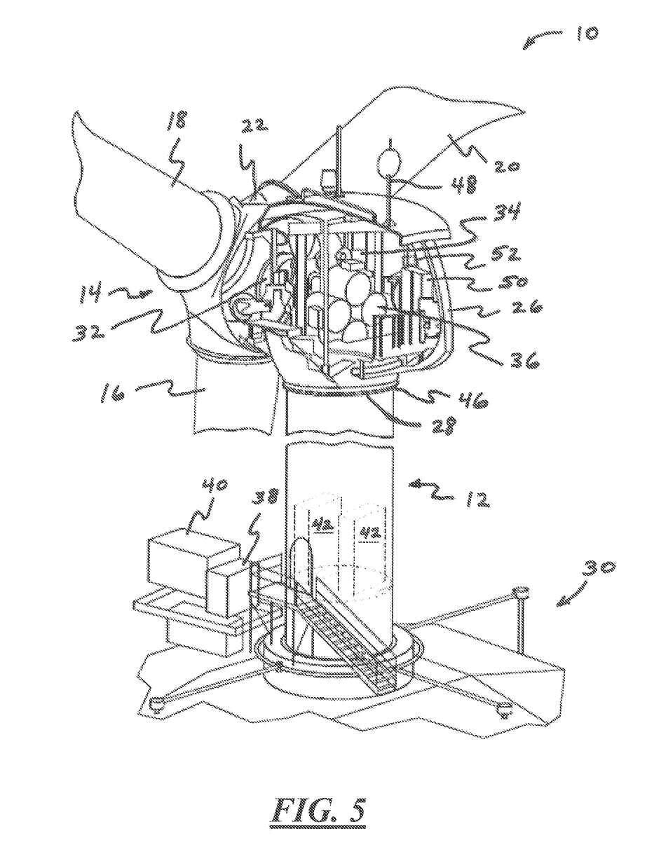

Turning to FIG. 5, the exemplary wind turbine 10 is illustrated with the components shown in greater detail. The tower 12 is shown with an intermediate section removed for inclusion of a base 30 of the wind turbine 10 in the drawing figure, and the rotor 14 is shown from behind for better illustration of the nacelle 26 and associated components. The blades 16, 18, 20 may rotate with wind energy and the rotor 14 may transfer that energy to a main shaft 32 situated within the nacelle 26. The nacelle 26 may optionally include a drive train 34, which may connect the main shaft 32 on one end to one or more generators 36 on the other end. Alternatively, the generator(s) 36 may be connected directly to the main shaft 32 in a direct drive configuration. The generator(s) 36 may generate power, which may be transmitted through the tower 12 to a power distribution panel (PDP) 38 and a pad mount transformer (PMT) 40 for transmission to a grid (not shown). The PDP 38 and the PMT 40 may also provide electrical power from the grid to the wind turbine 10 for powering several auxiliary components thereof. The base 30 may further include a pair of generator control units (GCUs) 42 and a down tower junction box (DJB) (not shown) to further assist in routing and distributing power between the wind turbine 10 and the grid.

The nacelle 26 may be positioned on a yaw system 46, which may pivot about the vertical axis a-a to orient the wind turbine 10 in the direction of the wind current. In addition to the aforementioned components, the wind turbine 10 may also include a pitch control system (not visible) having a pitch control unit (PCU) situated within the hub 22 for controlling the pitch (e.g., angle of the blades with respect to the wind direction) of the blades 16, 18, 20 and an anemometer 48 for measuring the speed, direction and turbulence of the wind relative to the wind turbine 10, with the turbulence representing the standard deviation of the wind speed (zero turbulence=constant wind speed). A turbine control unit (TCU) 50 having a control system 52 may be situated within the nacelle 26 for controlling the various components of the wind turbine 10 and for performing functions of the uprating control system.

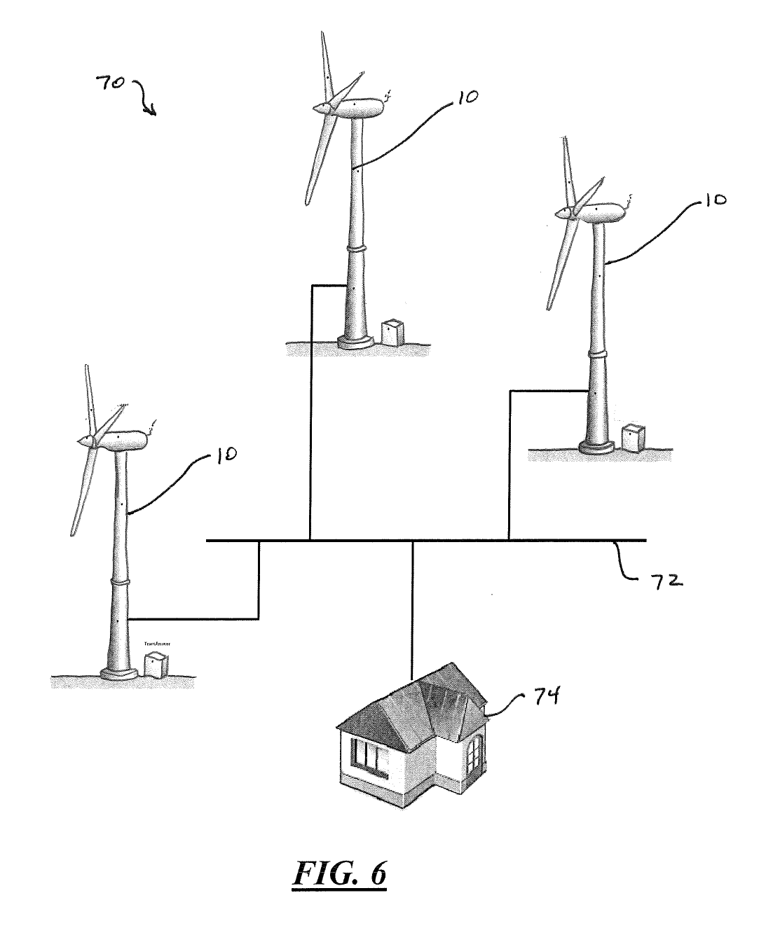

It is common for an owner/operator to have groups of the wind turbines 10 installed and operating in the same geographic area that is conducive to capturing the energy provided by the wind, such as in an area of open farmland or in a body of water. These areas provide flat open spaces free of obstructions that can block the wind. FIG. 6 provides a schematic illustration of a wind turbine farm 70 formed by a plurality of wind turbines 10. As discussed above, each wind turbine 10 may include generator control units 42 and control systems 52 in the turbine control unit 50 that may monitor the operations of the wind turbines 10 and implement control strategies for the safe operation of the wind turbines 10 according to their designs. The generator control units 42 and control systems 52 of the various wind turbines 10 may be connected via a network 72 to a central control center 74 that may be located at the wind turbine farm 70 or at a remote location. The logic for increasing the revenue generated over the design lives of the wind turbines 10 in accordance with the present disclosure may be performed solely at each wind turbine 10 by the control system 52, may be centralized at the control center 74 to implement a cohesive overall strategy for the wind turbine farm 70, or may have components of the system distributed between the control systems 52 of the wind turbines 10 and the control center 74 to ensure efficient execution of the various functions of the revenue optimization strategy. Alternatives for distribution of the functions of the strategy will be apparent to those skilled in the art and are contemplated by the inventor. Additionally, the wind turbines 10 may be added to the wind turbine farm 70 at different times, and will be at different stages of their useful life spans. Consequently, the actual torque and power relative to the rated values at a given time varies between wind turbines 10 of the wind turbine farm 70.

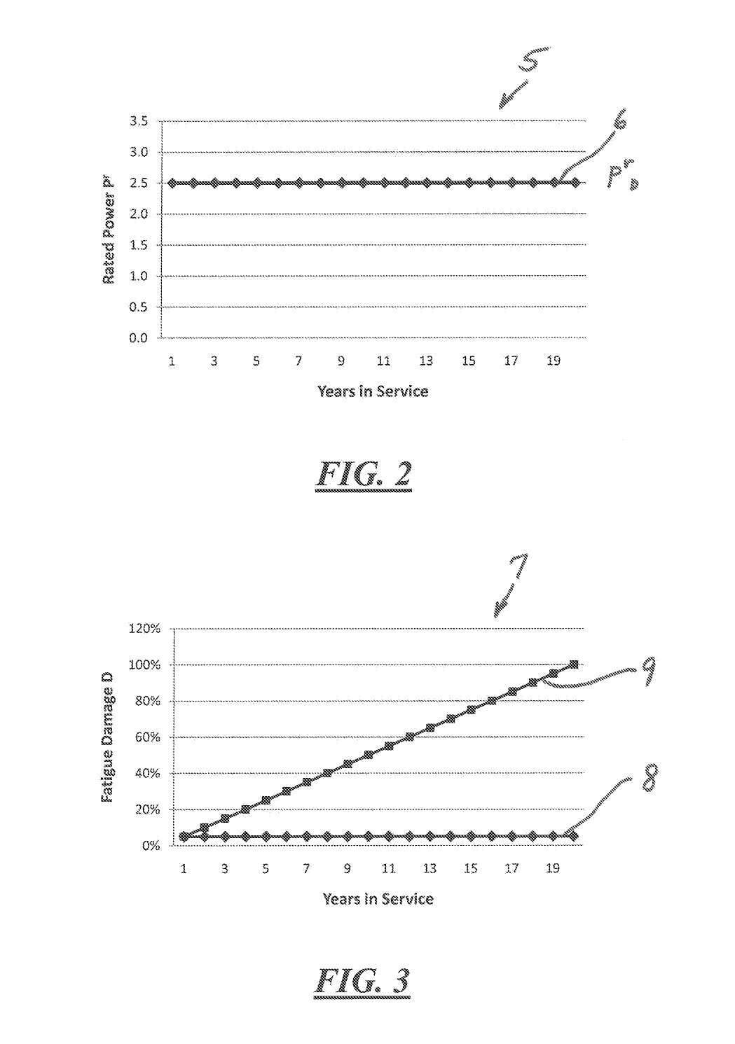

As discussed above, the wind turbines 10 typically are controlled to operate according to the rated power P^{r} and fatigue damage D versus time curves 6, 8 shown in FIGS. 2 and 3, respectively. In the curves 6, 8, the rated power P^{r} remains constant at the designed rated power P^{r}_{D} for the design life of the wind turbine 10. Control strategies such as those provided by the references discussed above may provide for some variation in the rate power P^{r} to operate above or below the designed rated power P^{r}_{D} to ensure that the useful lives of the components and structures of the wind turbine 10 are fully used up at the end of the 20 year life span. These control strategies focus on the fixed amount wear and tear that a wind turbine 10 can accumulate before it must be taken out of service.

The present disclosure recognizes that the reward to the owner in terms revenue generated by the wear and tear incurred by the wind turbine 10 varies over time. For example, due to the time value of money, energy produced early in the life of the wind turbine 10 is much more valuable than energy produced at the end of the design life of the wind turbine 10. Based on factors such as the interest rate and inflation rate, energy used in the first year of operation can be on the order of 10 times more valuable to the owner of the same amount of energy produced in the last year of operation. Moreover, the price of energy fluctuates over time. The price can fluctuate with daily, weekly and seasonally based on demand for the energy, and may also fluctuate due to market forces such as the price of fossil fuels. The wind turbine 10 has a fixed amount of wear and tear to “spend” or “invest,” and the present disclosure presents strategies for spending the available wear and tear more quickly and profitably when the value is high, and less quickly when the value is low.

In some embodiments, a control strategy may be configured to operate a wind turbine 10 to produce more power in the early years of operation, and less power in later years. Rather than producing a consistent amount of power every year over the life of the wind turbine 10, the control system may be programmed to allow the wind turbine 10 to operate at an actual rated power P^{r}_{A} above the designed rated power P^{r}_{D} during its early years, thereby producing at least slightly more power than its nameplate maximum power rating whenever possible. Then, during the later years, the actual rated power P^{r}_{A} allowed by the control system to be produced by the wind turbine 10 will be reduced below the designed rated power P^{r}_{D}.

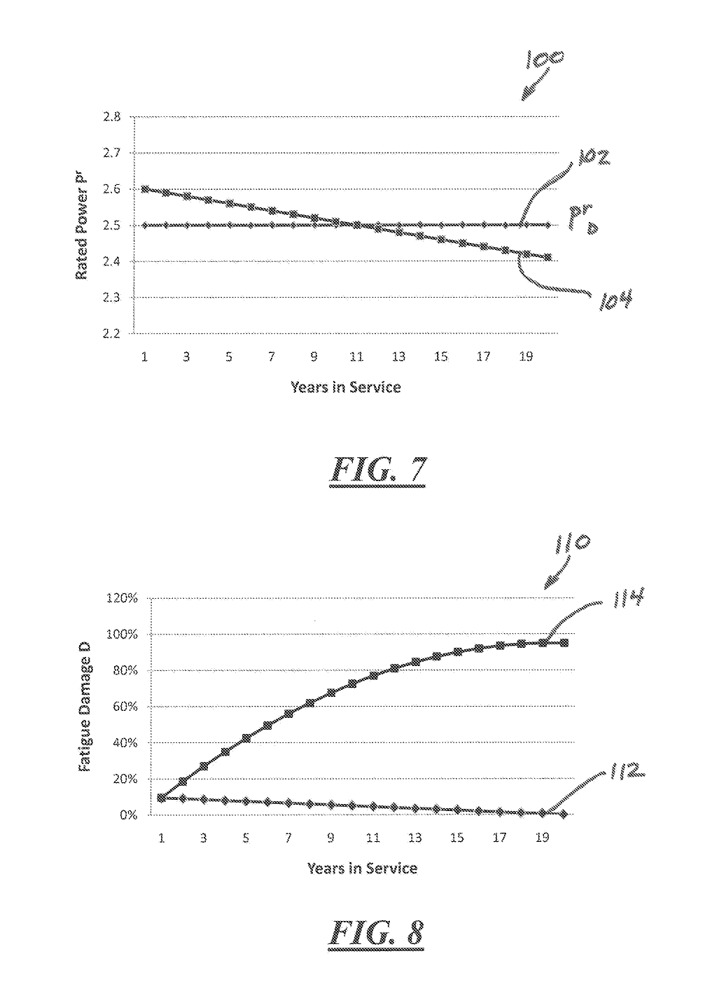

FIGS. 7 and 8 illustrate an exemplary implementation of a front loaded revenue optimizing strategy. FIG. 7 provides a graph 100 of the rated power P^{r} versus time, and FIG. 8 provides a graph 110 of the fatigue damage D versus time. The wind turbine 10 in this example may have a designed rated power P^{r}_{D} of 2.5 MW. The power ratings used in the examples herein are illustrative only. Those skilled in the art will understand that the specific examples are not limiting in the sizes and power production capacities of wind turbines 10 in which the operations and control in accordance with the present disclosure may be implemented. The rated power graph 100 of FIG. 7 includes a base line 102 showing the wind turbine 10 at the designed rated power P^{r}_{D} of 2.5 MW over the entire design life. Despite the designed rated power P^{r}_{D}, the control system may allow a wind turbine 10 to begin its life operating at an actual rated power P^{r}_{A} of 2.6 MW. At the tail end of the life of the wind turbine 10, the actual rated power P^{r}_{A} may be decreased to 2.4 MW by the control system. A linear decrease in the actual rated power P^{r}_{A} is illustrated by line 104 on the graph 100. A typical 2.5 MW-rated wind turbine 10 would be constructed, i.e. the same mechanical structures, bearings, etc. A wind turbine 10 designed to operate nominally at 2.5 MW can, in most conditions, operate safely at 2.6 MW with all loads being within acceptable margins of safety. The difference lies in the rate of fatigue damage D accumulated. The wind turbine 10 operating at 2.6 MW in its early years accumulates damage at a faster rate than one operating at 2.4 MW in the later years. Despite incurring fatigue damage D at a higher rate early in the life of the wind turbine 10, the total accumulated fatigue damage D over the life of the wind turbine 10 remains at or slightly below the designed lifetime damage accrual.

The operation of the wind turbine 10 may also be expressed in terms of a non-linear fatigue damage accumulation. In contrast to the linearly increasing accumulated damage curve 8 of FIG. 3, the wind turbine 10 accumulates fatigue damage D more quickly in the early years of operation as shown by the fatigue damage D versus time graph 110 of FIG. 8. In the graph 110, the annual damage shown by a line 112 is initially greater than that shown in FIG. 3, and decreases over time as the actual rated power P^{r}_{A} of line 104 of FIG. 7 decreases. Correspondingly, the cumulative damage shown by line 114 initially has a greater slope than the curve 8 of FIG. 3 and may gradually decrease in slope as the annual fatigue damage D decreases.

For purpose of illustration, the annual fatigue damage accumulation curve 112 is illustrated as incurring approximately 10% of the designed amount of lifetime fatigue damage D for the wind turbine 10 in the first year, and approximately linearly decreasing to close to no fatigue damage accumulation in the final year. Those skilled in the art will understand that it may not be feasible to incur such a high rate of fatigue damage D in one year without exceeding any maximum mechanical or electrical loads. Consequently, the maximum actual rated power P^{r}_{A} is practically limited by the load constraints. Therefore, in practice the annual fatigue damage D will be limited in the maximum amount by which it may exceed the fatigue damage D incurred by operating at the designed rated power P^{r}_{D}, and the curve 112 may slope accordingly so that the design fatigue damage amount is not exceeded before the end of the design life of the wind turbine 10.

In the illustrated embodiments, the rated power P^{r} is shown as decreasing linearly over the life of the wind turbine 10. In practice, control strategy may be configured to decrease the rated power P^{r} continuously or at specified intervals such as weekly, monthly or yearly. The control strategy may alternatively be configured to reduce the rated power P^{r} upon the occurrence of specified triggering events during the life of the wind turbine 10. For example, the 2.5 MW wind turbine 10 may be initially set to operate at an actual rated power P^{r}_{A} of 2.6 MW, and the control strategy may be configured to reduce the rated power P^{r} by 0.01 MW when an initial specified amount of fatigue damage D is accumulated, such as 10% of the designed lifetime damage accrual. The control strategy may then cause the rated power P^{r} to be reduced by an additional 0.01 MW when a second specified amount of fatigue damage D is accumulated, and continue to reduce the rated power P^{r} as subsequent fatigue damage milestones are reached so that fatigue damage D and, correspondingly, revenues are generated at an accelerated rate without exceeding the designed lifetime damage accrual. In such a control strategy, the historical and forecast wind conditions for the area in which the wind turbine 10 will be installed may be used to establish the triggering fatigue damage accumulation milestones so that the changes in the rated power P^{r} over time and the accumulation of fatigue damage D may be similar to those shown in FIGS. 7 and 8 if the winds match the historical and forecast conditions.

If the actual wind conditions match the historical and forecast conditions in the exemplary control strategy, the rated power P^{r} may be reduce by 0.01 MW approximately every year for the life of the wind turbine 10. However, the control strategy may also adjust for variations in the actual wind conditions experienced by the wind turbine 10. If the actual wind conditions exceed the forecast, fatigue damage D may accumulate at a faster rate than anticipated in the design. The wind turbine 10 may reach the initial fatigue damage accumulation triggering milestone more quickly and cause the rated power P^{r} to be reduced sooner to slow the accumulation of fatigue damage D. Conversely, where the actual wind conditions are less than forecasted, the fatigue damage D may accumulate more slowly and the rated power P^{r} may be maintained for a longer period of time before a fatigue damage accumulation triggering milestone is reached. As a result, the actual rated power curves and annual fatigue curves for wind turbines 10 operating under such a control strategy may still have downward trends, but may not necessarily decrease as linearly as depicted in FIGS. 7 and 8.

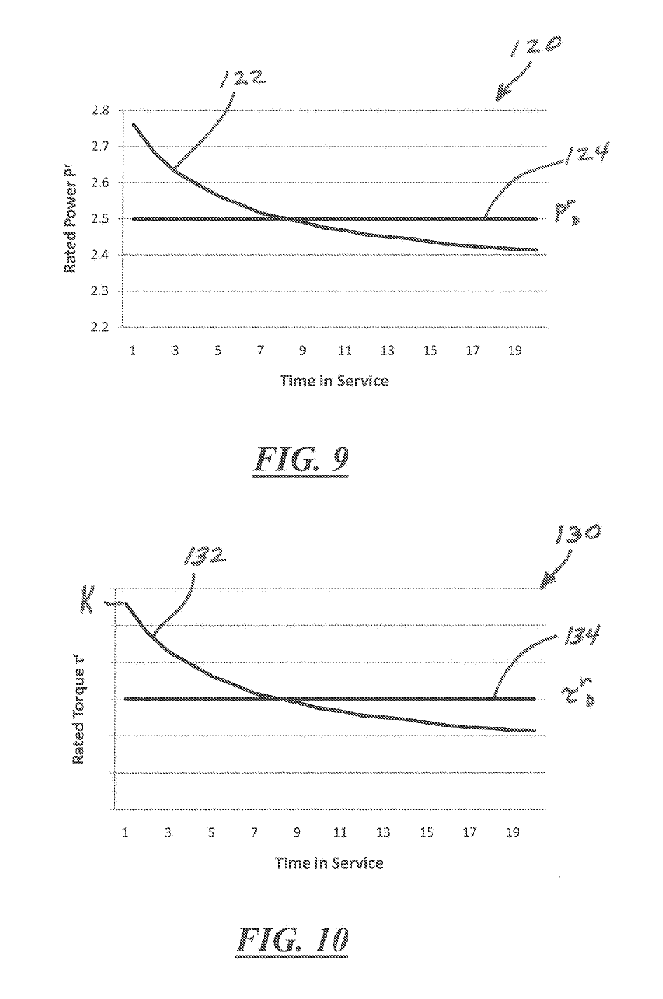

The above-described control strategies may operate the wind turbines 10, by design or in practice, with approximately linearly decreasing rated power P^{r} over the life of the wind turbines 10. Of course, additional control strategies are contemplated by the inventors having an initial actual rated power P^{r}_{A} that is greater than the designed rated power P^{r}_{D} and decreases at a varying rate over time to provide the owner of the wind turbine 10 with an accelerated revenue flow early in the life of the wind turbine. FIG. 9 provides an example of a rated power P^{r} versus time graph 120 for a control strategy wherein a line 122 represents an actual rated power P^{r}_{A} curve decreasing at a variable rate over time as the wind turbine 10 operates. A line 124 represents the designed rated power P^{r}_{D} for the wind turbine 10, with the initial actual rated power P^{r}_{A} being greater than the designed rated power P^{r}_{D}. The specific shape of the curve 122 may be based on various factors relating to the operation of the wind turbine 10 and to the economics of operating the wind turbine 10.

In one embodiment, the shape of the curve 122 may be determined based on an optimal re-rating of the wind turbine 10 utilizing the time value of money and the effect of operating the wind turbine 10 above the designed rated power P^{r}_{D}. In the wind turbine 10, the rated power P^{r} may be expressed by the following equation:

P^{r}=τ^{r}·Ω^{r} (1)

where τ^{r} is the rated torque and Ω^{r} is the rated angular velocity. Assuming that the rated angular velocity Ω^{r} remains substantially constant as the rated power P^{r} varies, the rated torque τ^{r} may vary in a similar manner as the rated power P^{r}. FIG. 10 presents a graph 130 of rated torque τ^{r} versus time for the wind turbine 10 corresponding to the rated power P^{r} versus time graph 120 of FIG. 9. Line 132 represents an actual rated torque τ^{r}_{A} curve, and line 132 represents the designed rated torque τ^{r}_{D} as a constant for reference.

In the illustrated embodiment, the actual rated torque τ^{r}_{A} curve 132 may be expressed by the following equation:

$${τ}_{A}^{r} = K {e}^{- \frac{r}{m - 1} t} \qquad ( 2 )$$

where K is an initial value of the actual rated torque τ^{r}_{A}, r is the interest rate or discount rate per year assumed to be constant over the design life of the wind turbine 10 for the following analysis, and m is a slope of a damage rate S-n curve (non-dimensional) for a component governing the design life of the wind turbine 10. The initial torque value K may also be expressed as a function of the interest rate r and the slope m of the damage rate curve for the governing component as will be discussed further hereinafter.

The values of the interest rate r and the slope m also dictate the shape of the curve 132. The higher the interest rate r, the greater the initial slope of the curve 132. This is reflective of the fact that it becomes more advantageous to generate revenues early in the life of the wind turbine 10 when interest rates are high and the owner can realize a greater return on the generated revenues. Conversely, lower interest rates reduce the value of generating revenues early and will draw the actual rated torque τ^{r}_{A} curve 132 closer to the designed rated torque τ^{r}_{D} curve 134.

The slope m may have the opposite effect on the shape of the actual rated torque τ^{r}_{A} curve 132. As the slope m of the damage rate curve increases, the curve 132 will flatten and move closer to the designed rated torque τ^{r}_{D} curve 134. The slope m of the damage rate curve is a measure of the amount of change in the damage accumulation rate for the component when the torque τ increases or decreases. The greater the change in the damage accumulation rate for the component when the torque τ changes, then the greater the value of the slope m of the damage rate curve. When the fatigue damage D increases at a significantly faster rate, it is less desirable to increase the rated power P^{r} above the designed rated power P^{r}_{D} and potentially exceed the designed fatigue damage limit before the end of the designed life of the wind turbine 10. However, where the slope m of the damage rate curve is low, the damage rate may be relatively inelastic with respect to the torque τ, thereby allowing the wind turbine 10 to operate above the designed rated power P^{r}_{D} with less additional accumulation of fatigue damage D over time.

The value of the initial torque K may be determined and a comparison of the net present values for operating the wind turbine 10 at the designed rated power P^{r}_{D} and according to the actual rated torque τ^{r}_{A} curve 132 may be obtained. The following simplified model assumes that the designed life of the wind turbine 10 is constrained by a gearbox torque within the drive train 34, and the gearbox is designed to use up all of its component life if the wind turbine 10 operates at its designed rated power P^{r}_{D} for the designed or projected lifetime T. The accumulated fatigue damage D for the gearbox over the projected design lifetime T of the wind turbine 10 may be expressed by the following equation:

D=∫₀^{T}k_{D}τ^{m}CFdt (3)

where k_{D} is a damage constant and CF is a non-dimensional capacity factor estimating a percentage of design rated capacity used per year by the wind turbine 10 based on the historical and forecast wind conditions in the area in which the wind turbine 10 is installed.

The fatigue damage D for any component will be equal to 1 at the end of the projected lifetime T in the hypothetical situation where the wind turbine 10 operates at the designed rated torque τ^{r}_{D} for the entire projected lifetime T and the component life is completely used up. Substituting for the fatigue damage D in equation (3)

∫₀^{T}k_{D}τ^{r}_{D}^{m}CFdt=1 (4)

Solving for the damage constant k_{D}:

$${k}_{D} = \frac{1}{{{τ}_{D}^{r}}^{m} CFT} \qquad ( 5 )$$

The net present value NPV of revenues generated by the operation of the wind turbine 10, ignoring capital costs and maintenance costs associated with the wind turbine 10, may be expressed as follows:

NPV=∫₀^{T}e^{-rt}pτω^{r}CFdt (6)

where p is the energy price and the rated angular velocity ω^{r} is expressed in rad/s. Combining the net present value NPV equation (6) and the damage constant k_{D} equation (5) using the method of Lagrange multipliers:

[symbol]

=∫₀^{T}e^{-rt}pτΩ^{r}CFdt+λ(1−∫₀¹k_{D}τ^{m}CFdt) (7)

where λ is the Lagrange multiplier. Differentiating equation (7) to find the conditions at the optimum:

e^{-rt}pτω^{r}CF−λk_{D}mτ^{m-1}CF=0 (8)

Solving equation (8) for the torque τ:

$$\begin{matrix}\begin{matrix}τ = {( \frac{{e}^{- rt} p {Ω}^{r}}{λ {k}_{D} m} )}^{1 / m - 1} \\ = K {e}^{- \frac{r}{m - 1} t}\end{matrix} & ( 9 ) \\ K = {( \frac{p {Ω}^{r}}{λ {k}_{D} m} )}^{1 / m - 1} & ( 10 )\end{matrix}$$

Substituting equation (9) for the torque τ in equation (4) and solving for the initial torque K:

$$\begin{matrix}{\int }_{0}^{T} {k}_{D} {K}^{m} {e}^{- \frac{rm}{m - 1} t} CF d t = 1 & ( 11 ) \\ {k}_{D} {K}^{m} ( - \frac{m - 1}{rm} ) {CF [ {e}^{- \frac{rm}{m - 1} t} ]}_{0}^{T} = 1 & ( 12 ) \\ {k}_{D} {K}^{m} \frac{m - 1}{rm} CF ( 1 - {e}^{- \frac{rmT}{m - 1}} ) = 1 & ( 13 ) \\ K = {( \frac{rm}{{k}_{D} ( m - 1 ) CF ( 1 - {e}^{- \frac{rmT}{m - 1}} )} )}^{1 / m} & ( 14 )\end{matrix}$$

Substituting for damage constant k_{D} from equation (5):

$$\begin{matrix}K = {( \frac{rm {{τ}_{D}^{r}}^{m} CFT}{( m - 1 ) CF ( 1 - {e}^{- \frac{rmT}{m - 1}} )} )}^{1 / m} & ( 15 ) \\ K = {{τ}_{D}^{r} ( \frac{m}{m - 1} \frac{rT}{1 - {e}^{\frac{- rmT}{m - 1}}} )}^{1 / m} & ( 16 )\end{matrix}$$

Knowing the value of the initial torque K, the net present value NPV of revenues generated as a function of the interest rate r and the slope m of the damage rate curve can be determined:

NPV=∫₀^{T}e^{-rt}pτΩ^{r}CFdt (17)

Substituting for the torque τ as expressed in equation (9):

$$\begin{matrix}NPV = {\int }_{0}^{T} {e}^{- rt} pK {e}^{- \frac{r}{m - 1} t} {Ω}^{r} CF d t & ( 18 ) \\ NPV = {\int }_{0}^{T} pK {Ω}^{r} CF {e}^{- \frac{rm}{m - 1} t} d t & ( 19 ) \\ NPV = pK {Ω}^{r} CF \frac{m - 1}{rm} ( 1 - {e}^{\frac{- rmT}{m - 1}} ) & ( 20 )\end{matrix}$$

Substituting for the initial torque K per equation (16) and simplifying:

$$NPV = {( \frac{m - 1}{m} \times \frac{1 - {e}^{\frac{- rmT}{m - 1}}}{rT} )}^{\frac{m - 1}{m}} p {τ}_{D}^{r} {Ω}^{r} CFT \qquad ( 21 )$$

This can be compared to the designed net present value NPV_{D} for the nominal case with the wind turbine 10 operating with the constant designed rated torque τ^{r}_{D}:

$$\begin{matrix}{NPV}_{D} = {\int }_{0}^{T} {e}^{- rT} p {τ}_{D}^{r} {Ω}^{r} CF d t & ( 22 ) \\ {NPV}_{D} = \frac{1}{r} ( 1 - {e}^{- rT} ) p {τ}_{D}^{r} {Ω}^{r} CF & ( 23 ) \\ {NPV}_{D} = \frac{1 - {e}^{- rT}}{rT} p {τ}_{D}^{r} {Ω}^{r} CDT & ( 24 )\end{matrix}$$

Equations 16 and 21 show that in this example the optimized initial torque K and the optimized net present value NPV are dependent on the interest rate r and the slope m of the damage rate curve. Similar to equation (2) for the torque τ, the values for the initial torque K and the net present value NPV will generally increase when the interest rate r increases, and will decrease when the slope m of the damage rate curve increases. Increases in the interest rate r provide incentive for increasing the initial torque K and generating more power when doing so increases the overall return for the owner during the life of the wind turbine 10. Where larger increases in the accumulation of fatigue damage D occur as the torque τ is increased as indicated by a large damage rate curve slope m, operating the wind turbine 10 significantly above the designed rated torque τ^{r}_{D} may cause the wind turbine 10 to be shut down earlier than the end of the design life of the equipment.

Each of the previously discussed control strategies involves the operation of the wind turbine 10 at an initial actual rated power P^{r}_{A} that is greater than the designed rated power P^{r}_{A} in order to take advantage of the time value of money and the corresponding financial benefit of generating revenue earlier during the design life of the wind turbine 10. However, fluctuations in the energy price p can influence the owner's return on investment in the wind turbine 10. The preceding example assumed a constant energy price p over the life of the wind turbine 10, but in reality, the energy price p fluctuates up and down over time, and can have predicable peaks and valleys that occur seasonally as the demand for electrical power increases and decreases due to the needs of the users to respond to their environment. Moreover, unpredictable spikes in the energy price p can occur when unforeseen events occur, such as natural disasters and other events affecting the supply network for electrical power. In view of these variations, control strategies may be implemented to adjust the actual rated power P^{r}_{A} in response to changes in the energy price p.

In one embodiment of a price-responsive control strategy, current and forecast values for the energy price p may be input to the control strategy. With the current and forecast values of the energy price p known, the control strategy may optimize the actual rate power P^{r}_{A} by determining the most profitable time to increase the rated power P^{r}. Where the forecast energy price p_{F} indicates a decrease from the current energy price p_{C}, the control strategy may determine that the decrease will be significant enough that the actual rate power P^{r}_{A} should be increased in the short term to allow the wind turbine 10 to produce more power at the higher current energy price p_{C}. Where the forecast energy price p_{F} indicates an upward trend from the current energy price p_{C}, the control strategy may determine that an increase in the actual rate power P^{r}_{A} should be deferred until the anticipated increase in the energy price p. The control strategy may further configured for the inputting of unexpected spikes in the energy price p and to react to the unforecasted changes to the energy price p to increase or decrease the actual rate power P^{r}_{A} as appropriate. Depending on the implementation, such energy price optimization strategies may be used as an alternative to the net present value optimization strategies discussed above, or as an enhancement to the net present value optimization strategies wherein the generally decreasing actual rate power P^{r}_{A} may be overridden as appropriate to produce power and capture revenues at their optimal value. For example, an expected time history of prices may be used as the energy price p in the derivation of the net present value set forth above.

In other embodiments of the control strategy, current and future weather forecasts may be input to the control strategy to increase the rate power P^{r} when sustained high winds are expected and to set the rated power P^{r} at or below the designed rated power P^{r}_{D} when low winds are expected. For example, where the weather forecast calls for high winds of the next few days that may generate 2.6 MW of power, and mild winds the following week that would produce less than 1.5 MW of power, the control strategy may increase the rated power P^{r} during the period of sustained winds, and reduce the rated power P^{r} to the designed rated power P^{r}_{D} or lower during the period of mild winds. Increasing the rated power P^{r} during periods where extra revenue may be generated may compensate for periods where revenues are expected to be well below the capacity of the wind turbine 10.

Unlike previously know control strategies for wind turbines, those described herein factor in the optimal timing for adjusting the rated power of the wind turbines to optimize the revenues generated by the wind turbines over their design lives. By increasing the rated power P^{r} above the designed rated power P^{r}_{D} early in the life of the wind turbine, energy may be generated sooner to take advantage of the time value of money to increase the overall return on investment for the owner of the wind turbine. As a tradeoff, fatigue damage D may initially be accumulated more quickly by the wind turbine, but the rated power P^{r} can be reduced later in the design life of the wind turbine to ensure that the components of the wind turbine do not wear out before the end of the design life. However, by producing power earlier in the life of the wind turbine, or selectively during the life of the wind turbine when the energy price p will yield the greatest return, the owner can realize a greater profit on their investment in the wind turbine while consuming the same component life.

The present application generally illustrates and describes the wind turbine 10 as being a horizontal axis type machine, but the optimization strategies may also be implemented in vertical axis wind turbines that are known in the art. Moreover, the optimization strategies set forth herein may have application in other types of energy generation systems to optimize the revenues generated by such systems. For example, similar strategies may be implemented in other fluid flow turbines such as conventional gas turbine generation facilities to generate more power early in the design lifetime of the turbine or at times when the energy price p will yield greater returns. Optimization strategies may also be implemented in solar panels to generate more energy early in the life of the solar panel and when the energy price p is high. The strategy may also allow the solar panel to generate more energy when the weather forecast is favorable for generating energy and reduce the energy that may be generated when the weather forecast is unfavorable. Those skilled in the art will understand that the optimization strategies may be implemented in these and other energy generation systems, and the use of the optimization strategies in such systems is contemplated by the inventor.

While only certain embodiments have been set forth, alternatives and modifications will be apparent from the above description to those skilled in the art. These and other alternatives are considered equivalents and within the spirit and scope of this disclosure and the appended claims.

I claim:

1. A method of operating a fluid flow turbine, comprising:
determining a design rated power for operation of the fluid flow turbine during a design lifetime of the fluid flow turbine;
determining an initial actual rated power for the fluid flow turbine, wherein the initial actual rated power is great than the design rated power;
initially operating the fluid flow turbine at an actual rated power equal to the initial actual rated power; and
decreasing the actual rated power from the initial actual rated power over time.

2. The method of claim 1, comprising decreasing the actual rated power linearly from the initial actual rated power over time.

3. The method of claim 1, comprising decreasing the actual rated power incrementally in response to an occurrence of a triggering event, wherein the triggering event is one of an expiration of a predetermined time interval and an accumulation of a predetermined amount of accumulated fatigue damage during operation of the fluid flow turbine.

4. The method of claim 1, comprising decreasing the actual rated power at a varying rate over time during the design lifetime of the fluid flow turbine, wherein a rate of change of the actual rated power decreases over time.

5. The method of claim 4, wherein the actual rated power of the fluid flow turbine is equal to a product of an actual rated torque and an actual rated speed of the fluid flow turbine, and wherein the actual rated torque of the fluid flow turbine is expressed by the equation:
$${τ}_{A}^{r} = K {e}^{- \frac{r}{m - 1} t}$$
where τ^{r}_{A} is the actual rated torque, K is an initial actual rated torque that produces the initial actual rated power, r is a discount rate per year, and m is a slope of a damage rate curve for a component of the fluid flow turbine.

6. The method of claim 5, wherein the initial actual rated torque is expressed by the equation:
$$K = {{τ}_{D}^{r} ( \frac{m}{m - 1} \frac{rT}{1 - {e}^{\frac{- rmT}{m - 1}}} )}^{1 / m}$$
where τ^{r}_{D} is a design rated torque for the fluid flow turbine and T is the design lifetime for the fluid flow turbine.

7. The method of claim 1, comprising:
comparing a current energy price for a current time period for energy generated by the fluid flow turbine to a forecast energy price for a future time period; and
operating the fluid flow turbine at a current actual rated power during the current time period that is greater than the actual rated power for the current time period in response to determining that the current energy price is greater than the forecast energy price.

8. A method of operating a fluid flow turbine, comprising:
operating the fluid flow turbine to avoid exceeding a rated power output;
establishing an initial rated power output of the fluid flow turbine; and
decreasing the rated power output from the initial rated power output over a design lifetime of the fluid flow turbine such that an actual power output of the fluid flow turbine gradually decreases.

9. The method of claim 8, comprising linearly decreasing the rated power output of the fluid flow turbine from the initial rated power output over time.

10. The method of claim 8, comprising decreasing the rated power output incrementally in response to an occurrence of a triggering event, wherein the triggering event is one of an expiration of a predetermined time interval and an accumulation of a predetermined amount of accumulated fatigue damage during operation of the fluid flow turbine.

11. The method of claim 8, comprising decreasing the rated power output at a varying rate over time, wherein a rate of change of the rated power output decreases over time.

12. The method of claim 11, wherein the rated power output of the fluid flow turbine is equal to a product of an actual rated torque and an actual rated speed of the fluid flow turbine, wherein the actual rated torque of the fluid flow turbine is expressed by the equation:
$${τ}_{A}^{r} = K {e}^{- \frac{r}{m - 1} t}$$
where τ^{r}_{A} is the actual rated torque, K is an initial value of the actual rated torque, r is a discount rate per year, and m is a slope of a damage rate curve for a component of the fluid flow turbine, and wherein the initial value of the actual rated torque is expressed by the equation:
$$K = {{τ}_{D}^{r} ( \frac{m}{m - 1} \frac{rT}{1 - {e}^{\frac{- rmT}{m - 1}}} )}^{1 / m}$$
where τ^{r}_{D} is a design rated torque for the fluid flow turbine and T is the design lifetime for the fluid flow turbine.

13. The method of claim 8, comprising:
comparing a current energy price for a current time period for energy generated by the fluid flow turbine to a forecast energy price for a future time period; and
operating the fluid flow turbine at a current actual rated power during the current time period that is greater than the rated power output for the current time period in response to determining that the current energy price is greater than the forecast energy price.

14. A method of operating a fluid flow turbine, comprising:
determining a rated power for operating the fluid flow turbine;
comparing a current energy price for a current time period for energy generated by the fluid flow turbine to a forecast energy price for a future time period;
setting a current period actual rated power equal to a value that is greater than the rated power in response to determining that the current energy price is greater than the forecast energy price; and
operating the fluid flow turbine at the current period actual rated power during the current time period.

15. The method of claim 14, comprising:
setting a future period actual rated power equal to a value that is greater than the rated power in response to determining that the forecast energy price is greater than the current energy price; and
operating the fluid flow turbine at the future period actual rated power during the future time period.

16. The method of claim 15, comprising:
setting the current period actual rated power equal to the rated power in response to determining that the forecast energy price is greater than the current energy price; and
setting the future period actual rated power equal to the rated power in response to determining that the current energy price is greater than the forecast energy price.

17. The method of claim 15, comprising:
setting the current period actual rated power equal to a value that is less than the rated power in response to determining that the forecast energy price is greater than the current energy price; and
setting the future period actual rated power equal to a value that is less than the rated power in response to determining that the current energy price is greater than the forecast energy price.

18. The method of claim 14, comprising:
determining a first rated power for operating the fluid flow turbine during the current time period;
determining a second rated power for operating the fluid flow turbine during the future time period, wherein the second rated power is less than the first rated power;
setting the current period actual rated power equal to a value that is greater than the first rated power in response to determining that the current energy price is greater than the forecast energy price.

19. The method of claim 18, comprising:
setting a future period actual rated power equal to a value that is greater than the second rated power in response to determining that the forecast energy price is greater than the current energy price; and
operating the fluid flow turbine at the future period actual rated power during the future time period.

20. The method of claim 19, comprising:
setting the current period actual rated power equal to a value that is less than the first rated power in response to determining that the forecast energy price is greater than the current energy price; and
setting the future period actual rated power equal to a value that is less than the second rated power in response to determining that the current energy price is greater than the forecast energy price.
